(19) United States
(12) Patent Application Publication
(10) Pub. No.: US 2026/0195410 A1
(43) Pub. Date: Jul. 9, 2026

(54) METHODS FOR SOLVING MANY-BODY QUANTUM SYSTEM PROBLEMS

(71) Applicant: Microsoft Technology Licensing, LLC, Redmond, WA (US)

(72) Inventors: Matthias TROYER, Clyde Hill, WA (US); Chetan Vasudeo NAYAK, Santa Barbara, CA (US); Bradley Curtis LACKEY, Redmond, WA (US); Mathias SOEKEN, Montreux (CH)

(73) Assignee: Microsoft Technology Licensing, LLC, Redmond, WA (US)

(21) Appl. No.: 19/082,049

(22) Filed: Mar. 17, 2025

Related U.S. Application Data
(60) Provisional application No. 63/698,493, filed on Sep. 24, 2024.

(51) Int. Cl. G06F 17/17

(52) U.S. Cl. CPC G06F 17/17

(57) ABSTRACT

A computer-implemented method is presented for solving a many-body quantum system problem. The method comprises, at a classical computing device, receiving a many-body quantum system problem. A portfolio of approximate candidate methods for solving the many-body quantum system problem is received. Approximate solutions are generated to the many-body quantum system problem using the portfolio of approximate candidate methods. A quantum computing device is provided with the many-body quantum system problem and the approximate solutions. A quantum energy for each of the portfolio of approximate candidate methods is received from the quantum computing device. One or more approximate candidate methods are selected based on their respective quantum energy. For each of the selected approximate candidate methods, the many-body quantum system problem is solved using the one or more selected approximate candidate methods. Properties of a quantum state for the many-body quantum system are output.

### CROSS REFERENCE TO RELATED APPLICATIONS

This application claims priority to U.S. Provisional Patent Application Ser. No. 63/698,493, filed Sep. 24, 2024, entitled “METHODS FOR SOLVING MANY-BODY QUANTUM SYSTEM PROBLEMS”, the entirety of which is hereby incorporated herein by reference for all purposes.

### BACKGROUND

The accurate solution of many-body quantum systems, in particular the electronic structure problem of solving the behavior of interacting electrons in quantum systems for problems in fields such as materials science, biochemistry, and drug design, is exponentially hard on classical computers when performed exactly. Efficient classical methods are of unknown quality and with uncontrolled errors.

### SUMMARY

A computer-implemented method is presented for solving a many-body quantum system problem. The method comprises, at a classical computing device, receiving a many-body quantum system problem. A portfolio of approximate candidate methods for solving the many-body quantum system problem is received. Approximate solutions are generated to the many-body quantum system problem using the portfolio of approximate candidate methods. A quantum computing device is provided with the many-body quantum system problem and the approximate solutions. A quantum energy for each of the portfolio of approximate candidate methods is received from the quantum computing device. One or more approximate candidate methods are selected based on their respective quantum energy. For each of the selected approximate candidate methods, the many-body quantum system problem is solved using the one or more selected approximate candidate methods. Properties of a quantum state for the many-body quantum system are output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system configured for solving many-body quantum system problems.

FIG. 2 shows a flowchart for a classical-computer implemented method for solving many-body quantum system problems.

FIG. 3 shows a flowchart for a quantum-computer implemented method for solving many-body quantum system problems.

FIG. 4 shows an example phase diagram that may be output based on the methods of FIGS. 2 and 3.

FIG. 5 shows aspects of an example quantum computer in which the quantum computing elements of FIG. 1 may be enacted.

FIG. 6A illustrates a Bloch sphere, which graphically represents the quantum state of one qubit of the quantum computer of FIG. 5.

FIG. 6B shows aspects of an example signal waveform for effecting a quantum-gate operation or measurement in a quantum computer.

FIG. 7 is a schematic illustration of a lattice of physical qubits in one, non-limiting example.

FIG. 8 is a schematic diagram of an example classical computing device, in which the classical computing elements of FIG. 1 may be enacted.

### DETAILED DESCRIPTION

To reduce complexity from the full multi-body quantum problem with long-range Coulomb forces, often simplified, so-called effective models like the Hubbard, periodic Anderson or Heisenberg model are used, but even those are computationally expensive to solve. The key reason for the difficulty in solving these problems is that there can be a plethora of competing phases with extremely close energies but vastly different properties.

As an example, in tensor network calculations for the t-J and Hubbard models, the energy difference between uniform and stripe states is of the order of 0.001 t per site, while the difference between in-phase and antiphase paired stripes is around 0.001 t per hole. For the Hubbard model, energy differences between different stripe periods are also of the order of 0.001 t per site, and similar energy differences have been seen for broader comparisons of methods.

An example related to frustrated magnets is the Kagome Heisenberg model. Previously, it was shown that the ground state is a quantum spin liquid (QSL) and not a valence bond crystal, which required a resolution of 0.01 J. However, the competition between different QSL states is more subtle, e.g., in it was shown that the energy difference between a gapped Z2 QSL and a gapless U(1) Dirac QSL is of the order of 0.001 J. As another example, for the Shastry-Sutherland model (proposed for SrCu₂(BO₃)₂) an accuracy of better than 0.001 J is required to resolve the magnetization plateaus. These are extremely small energy differences, within uncertainties of classical approximate methods. This explains why many of these strong interaction quantum systems are hard to solve.

While quantum computers can solve these problems accurately in polynomial time the runtimes are long, and many qubits are required. The long runtimes originate from the need to simulate the time propagation of a quantum state for a time T=1/ϵ where ϵ is the target error. For the models above one wants to target ϵ=0.001 t for Hubbard models, ϵ=0.001 J for frustrated magnets and ϵ=0.001 Ha for chemistry problems. The cost for simulations grows with T=1/ϵ and in addition grows polynomially in the number of particles or lattice sites N.

There exists an abundance of approximate classical methods for solving atomic and molecular behavior problems. Such problems may include atomic and electron simulations. However, for each problem, it is not known which of these approximate classical methods are reliable and accurate for each problem type. Each method comprises an unknown, uncontrollable error.

Running each and every candidate approximate classical method to determine properties of the many-body quantum system, whether on a classical or quantum computer, is prohibitively costly. Instead, herein, methods are disclosed whereby a quantum computer may be used to determine which approximate classical methods are accurate, then only a subset of those classical methods can be executed on a classical or quantum computer at a great cost savings.

An objective is to calculate the energy of the quantum state for each approximate classical method. The approximate classical methods give a proposed quantum state or wave function. The ground state is the state that is relevant at room temperature for the system. The atoms and molecules in the system will tend towards the lowest energy state. For electrical and conductive materials and systems, the behavior of the electrons will be minimized at ground state (e.g., the wave function).

The methods with the lowest energy (e.g., ground state) represent the most reliable and most accurate approximate classical methods. The calculations performed at the quantum computer are not necessarily used to calculate the properties of the many bodies, but just to calculate the energies accurately enough so the most accurate approximate classical methods can be selected for further computations.

The methods disclosed herein thus reduce the cost of solving many-body quantum problems by several orders of magnitude. Currently, many low-energy classical approximation methods are available, but it is unknown which one is the right one for any given problem. The disclosed approach is thus a hybrid one. A classical computer is used to determine an approximate solution for a many-body quantum system problem using a portfolio of approximate candidate methods. A quantum computer is then used to determine a quantum energy for each of the approximate solutions. The approximate candidate method(s) that yielded the lowest quantum energies are selected as being reliable classical approximations for the many-body quantum system problem. Those approximate candidate methods are then used to solve for the approximate properties the many-body quantum system problem. Those approximations may be used to map out a phase or phase diagram for the many-body quantum system. This will provide value at significantly reduced computational cost. The disclosed methodology applies both to the full problem and to the effective models described above, such as Hubbard, periodic Anderson, and/or Heisenberg models.

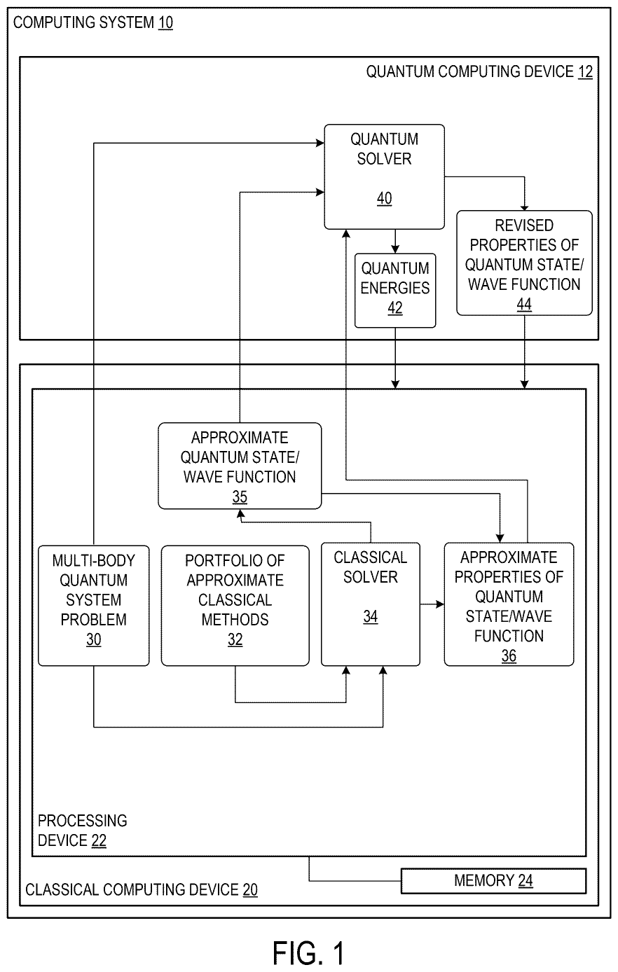

FIG. 1 schematically shows a computing system 10 at which many-body quantum system problems can be solved. The computing system 10 depicted in FIG. 1 includes a quantum computing device 12 that is configured to communicate with a classical computing device 20. The classical computing device 20 includes one or more processing devices 22 and memory 24. Instructions may be stored in memory for one or more computational methods for solving many-body quantum system problems.

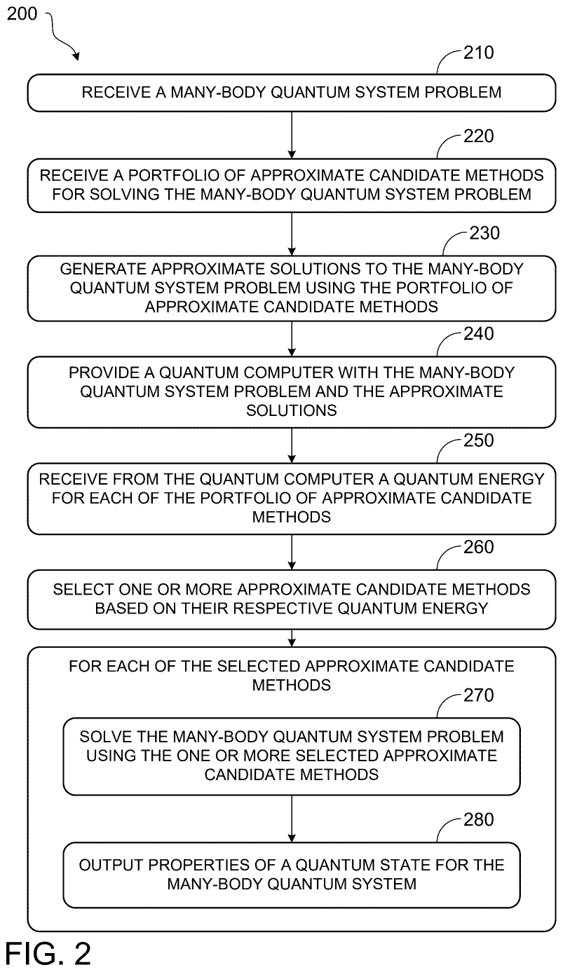

As an example, FIG. 2 shows a flow chart for an example classical computer-implemented method 200 for solving a many-body quantum system problem. Method 200 may be implemented at a classical computing device that is communicatively coupled to a quantum computing device, such as classical computing device 20.

At 210, method 200 comprises receiving a many-body quantum system problem. For example, FIG. 1 shows a multi-body quantum system problem 30. The many-body quantum system problem 30, for example, may be one or more of a materials science problem, a chemistry problem, a biochemistry problem, a drug design problem, a nuclear matter problem, and/or a plasma problem.

At 220, method 200 comprises receiving a portfolio of approximate candidate methods for solving the many-body quantum system problem. For example, FIG. 1 shows a portfolio of approximate classical methods 32. Each method in the portfolio of approximate classical methods can solve for a quantum system and produce approximate candidate ground states or candidate wave functions that represent the quantum state of the system. Approximate classical methods may include, but are not limited to, variational Monte Carlo, density matrix renormalization group, matrix product states, fixed node Monte Carlo, released node Monte Carlo, machine learning wave functions, and dynamical mean field theory.

At 230, method 200 comprises generating approximate solutions to the many-body quantum system problem using the portfolio of approximate candidate methods. For example, classical computing device 20 comprises a classical solver 34 that may be used to generate approximate quantum states and/or wave functions 35. In calculating approximate wave functions, each approximate candidate method may be applied to one or more lattice sizes and/or boundary conditions.

At 240, method 200 comprises providing a quantum computing device with the many-body quantum system problem and the approximate solutions generated from the portfolio of approximate candidate methods.

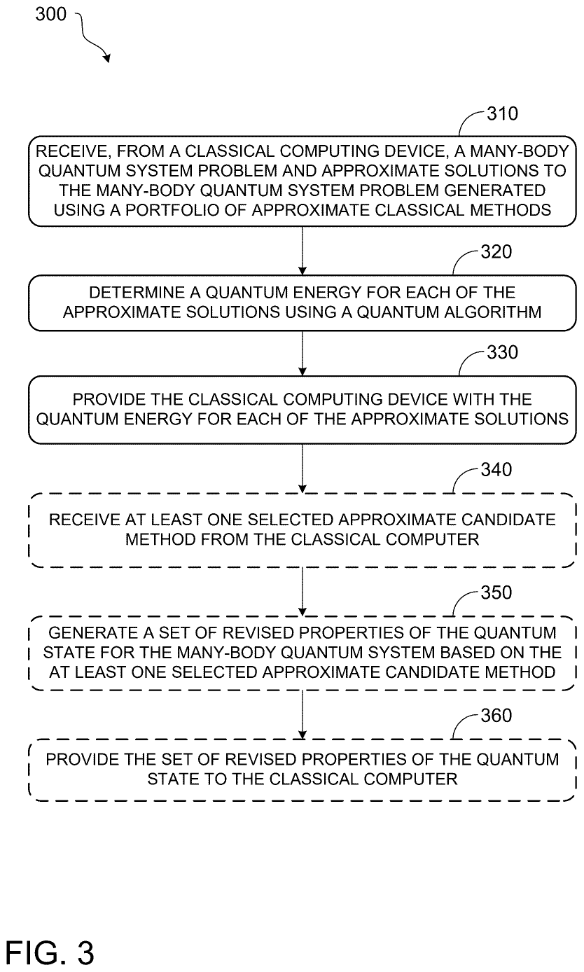

As an example, FIG. 3 shows a flow chart for an example quantum computer-implemented method 300 for solving a many-body quantum system problem. Method 300 may be implemented at a quantum computing device that is communicatively coupled to a classical computing device, such as quantum computing device 12.

At 310, method 300 includes receiving, from a classical computing device, a many-body quantum system problem and approximate solutions to the many-body quantum system problem generated using a portfolio of approximate classical methods.

At 320, method 300 includes determining a quantum energy for each of the approximate solutions using a quantum algorithm. As such, at the quantum computing device, an initial comparison of the ground states of the various approximate classical methods may be performed. The approximate solutions may be used to calculate quantum states and/or candidate wave functions. Quantum algorithms can include quantum phase estimation and variational quantum eigensolvers. Quantum phase estimation can use Trotterization, qubitization, quantum signal processing, or similar methods as the underlying decomposition.

The inputs to the quantum algorithm are the approximate quantum state, the model describing the quantum system, and the model parameters for the quantum system. For example, as shown in FIG. 1, quantum computing device 12 may comprise a quantum solver 40. The quantum solver 40 may take the quantum state and run the quantum algorithm (e.g., quantum phase estimation algorithm) to compute the energy of the quantum state. Quantum solver 40 may output quantum energies 42 for each of the approximate classical methods 32. Multiple states form multiple approximations that can be analyzed by quantum solver 40. From this output the quantum state that has the lowest energy can be determined. The corresponding approximate classical method 32 that yielded the quantum state with the lowest energy may be considered the most accurate approximation method. The exact quantum state can be used to calculate properties of the quantum state. At 330, method 300 includes providing the classical computing device with the quantum energy for each of the approximate solutions.

An accuracy of each of the classical approximations is based on the quantum energy calculated by the quantum solver. For example, an approximate wave function may be projected onto an eigenstate. The energy of the quantum state only needs to be measured to the accuracy of the difference of these quantum states for the approximate candidate methods. Put another way, to determine which candidate approximation method is most accurate, the quantum properties of the quantum state do not need to be fully computed for each candidate method. Rather the ground state only needs to be computed to a point where the accuracy diverges, for example on the order of 0.001. This is much less computationally expensive (e.g., 1000×) than calculating the quantum properties of the quantum states whereby the number N of lattice sides or orbitals must be taken account, and N is generally on the order of 100 to 1000. As such, accurate energy resolutions of 0.001 per site will create significant value by deciding about the true ground state phase and the best wave function describing it.

As mentioned above, the energies of competing proposed wave functions typically differ only by a tiny energy on the order of about ϵ≈0.001 per site. Notably, this is the energy difference per site. The target total energy accuracy is thus Nϵ, where N is the system size, which can be in the hundreds or thousands More importantly, with the resource effort scaling as O(N), and the required propagation time as 1/Nϵ, the total effort becomes O(1/ϵ) and independent of system size. The disclosed methods can thus determine the lowest energy ansatz wave function with efforts that are far less than initially expected.

Returning to FIG. 2, at 250, method 200 comprises receiving from the quantum computing device a quantum energy for each of the portfolio of approximate candidate methods. In some examples, the classical computing device may receive a wave function for one or more of the portfolio of approximate candidate methods from the quantum computing device. Once the best approximate classical methods are established, those can be used to solve the atomic/molecular problem by calculating the properties of the quantum states.

At 260, method 200 comprises selecting one or more approximate candidate methods based on their respective quantum energy. For each of the selected approximate candidate methods, at 270, method 200 comprises solving the many-body quantum system problem (e.g., calculating properties of the quantum system model) using the one or more selected approximate candidate methods. For example, as shown in FIG. 1, classical computing device 20 comprises classical solver 34 that can accomplish this task, outputting approximate properties of the quantum state or wave function 36.

At 280, method 200 comprises outputting properties of a quantum state for the many-body quantum system. In some examples, the classical computing device may output a wave function for the many-body quantum system.

In some examples, one or more approximate candidate methods are selected for each of two or more phases for the many-body quantum system problem. For a given atomic or molecular behavior problem, there may be different approximate classical methods that are most reliable for each phase of the problem. Each selected approximate classical method may output a model for a given phase. A family of models with changing parameters may be used to map out the phase diagram.

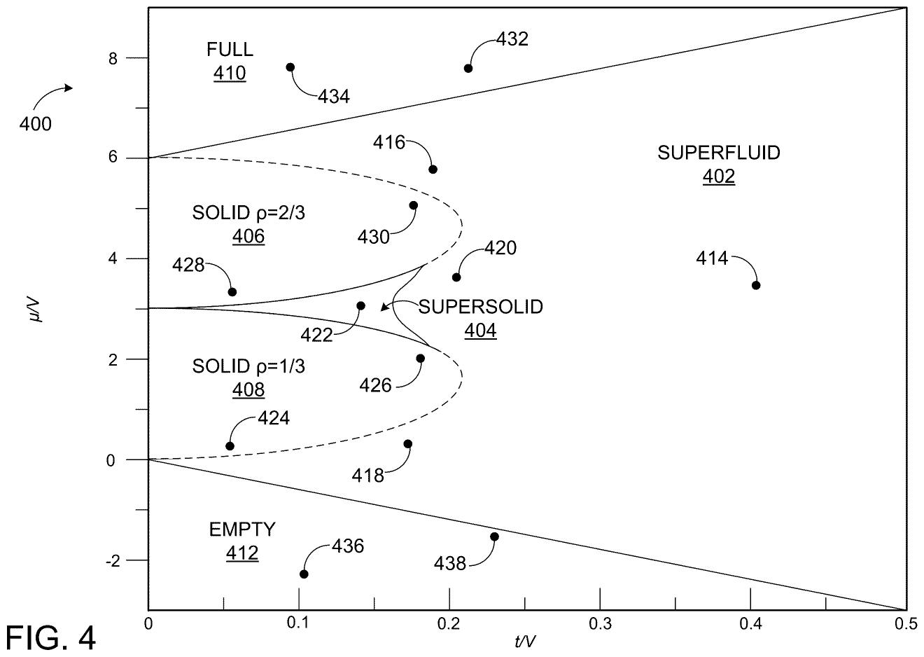

The phase diagram may indicate quantum properties as functions of parameters. For example, FIG. 4 shows an example phase diagram 400 for a multi-body system. Phase diagram 400 is a zero-temperature phase diagram of hardcore bosons on a triangular lattice in the grand canonical ensemble obtained from quantum Monte Carlo simulations. Phase diagram 400 shows phases for plot points for properties μ/V vs t/V, where μ is the chemical potential, t denoted the nearest-neighbor hopping, and V is the nearest-neighbor repulsion. Phase diagram 400 shows a superfluid phase 402, a supersolid phase 404, a solid phase where ρ=⅔ 406, a solid phase where ρ=⅓ 408, a phase where all sites are full 410, and a phase where all sites are empty 412. Second order phase transitions are denoted by solid lines, whereas first order phase transitions are denoted by dashed lines. In other examples, properties may additionally or alternatively include energy, density, magnetization (e.g., magnetic fields), coupling strength, interaction, anisotropy, temperature, pressure, structure, and/or electronic properties, such as insulator, semiconductor, metal, superconductor, magnet.

For each phase, the most reliable methods for that phase may thus be determined. Different preferred approximate classical methods may be indicated for each phase. Thus, method 200 may comprise outputting a phase diagram indicating properties of the quantum state for two or more phases of the many-body quantum system. As shown in FIG. 4, properties may be determined for one or more points in the superfluid phase 402 (e.g., points 414, 416, 418, 420) the supersolid phase 404 (e.g., point 422), the solid phase where ρ=⅓ 408 (e.g., points 424, 426), the solid phase where ρ=⅔ 406 (e.g., points 428, 430), the phase where all sites are full 410 (e.g., points 432, 434), and the phase where all sites are empty 412 (e.g., points 436, 438).

In some examples, method 200 may comprise providing at least one selected set of approximate properties to the quantum computing device. Returning to FIG. 3, at 340, method 300 optionally includes receiving at least one selected approximate candidate method from the classical computing device. At 350, method 300 optionally includes generating a set of revised properties of the quantum state for the many-body quantum system based on the at least one selected approximate candidate method. Quantum computations may be performed by a quantum solver, e.g., quantum solver 40 as shown in FIG. 1.

In this way, for the most promising quantum states and/or wave functions, quantum computations performed at the quantum computing device may provide added validation the quality of the classical method, which can then be used to determine properties of the systems that are only selectively checked with quantum computations. This hybrid approach reduces resource requirements by many orders of magnitude compared to naïve estimates.

Optionally, at 360, method 300 includes providing the set of revised properties of the quantum state to the classical computing device. For example, FIG. 1 shows revised properties of a quantum state/wave function 44. Method 200 may thus further comprise receiving a set of revised properties of the quantum state for the many-body quantum system from the quantum computing device.

As an example, for certain points in the phase diagram (e.g., as shown in FIG. 4), the approximation may be checked by performing an accurate quantum calculation. For mapping out a full phase diagram, traditionally maybe 10,000 calculations are needed. This can be reduced to 100 or 1000 classical computations, then on the order of 10 of those may be checked using quantum algorithms and simulations.

If desired, precise estimates for quantum computations can be derived targeting a precision of 0.001/N to compare and select from proposed approximate wave functions and for a precision of 0.001 for directly calculating properties of a ground or excited state fully quantumly, demonstrating the advantage of the disclosed methods. A rough estimate is an acceleration by a factor N/10 to N depending on the size N of problem, which is typically in the hundreds to thousands.

Methods 200 and 300 may be used in scenarios to validate experimental data. For example, the methods may be used to determine which model or set of models most closely fits the experiments by iterating the methods for a selection of models, and then comparing the resulting phase diagrams to the experimental data.

In some embodiments, the methods and processes described herein may be tied to a computing system of one or more computing devices. In particular, such methods and processes may be implemented as a computer-application program or service, an application-programming interface (API), a library, and/or other computer-program product.

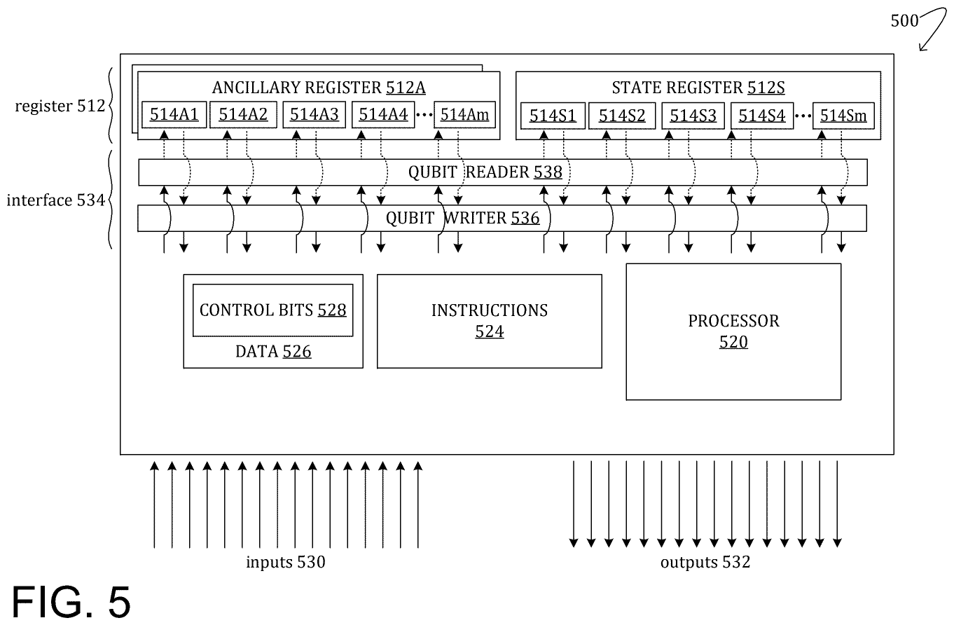

Some aspects of an example quantum-computer architecture will first be described. FIG. 5 shows aspects of an example quantum computer 500 configured to execute quantum-logic operations (vide infra). Quantum computer 500 may embody quantum computing device 12 described above and illustrated in FIG. 1. Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 500 of FIG. 5 includes a set of qubit registers 512 e.g., state register 512S and auxiliary register 512A. Each qubit register includes a series of qubits 514. The number of qubits in a qubit register is not particularly limited but may be determined based on the complexity of the quantum logic to be enacted by the quantum computer.

Qubits 514 of qubit register 512 may take various forms, depending on the desired architecture of quantum computer 500. Each qubit may comprise: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. A qubit may be implemented in the plural processing states corresponding to different modes of light propagation through linear optical elements (e.g., mirrors, beam splitters and phase shifters), as well as in states accumulated within a Bose-Einstein condensate. More generally, each qubit 514 may comprise any particle or system of particles that can exist in two or more discrete quantum states that can be measured and manipulated experimentally.

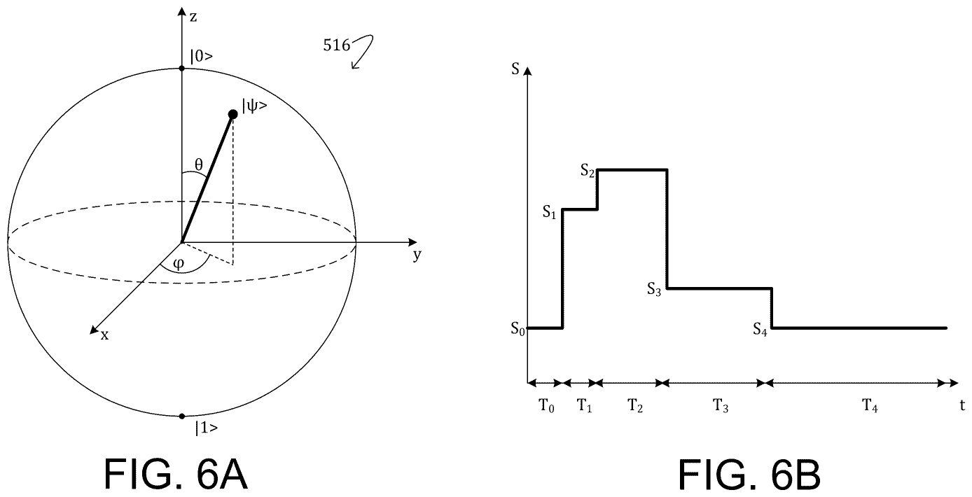

FIG. 6A is an illustration of a Bloch sphere 516, which provides a graphical description of some quantum mechanical aspects of an individual qubit 514. In this description, the north and south poles of the Bloch sphere correspond to the standard basis vectors |0 [symbol] and |1 [symbol] , respectively—up and down spin states, for example, of an electron or other fermion. The set of points on the surface of the Bloch sphere comprise all possible pure states |ψ [symbol] of the qubit, while the interior points correspond to all possible mixed states. A mixed state of a given qubit may result from decoherence, which may occur because of undesirable coupling to external degrees of freedom.

Returning now to FIG. 5, quantum computer 500 includes a controller 518. The controller may include at least one processor 520 and associated computer memory 522. Processor 520 may be coupled operatively to peripheral componentry, such as network componentry, to enable the quantum computer to be operated remotely. Processor 520 may take the form of a central processing unit (CPU), a graphics processing unit (GPU), or the like. As such, controller 518 may comprise classical electronic componentry. The terms ‘classical’ and ‘non-quantum’ are applied herein to any component that can be modeled accurately without considering the quantum state of any individual particle therein. Classical electronic components include integrated, microlithographed transistors, resistors, and capacitors, for example. Computer memory 522 may be configured to hold program instructions 524 that cause processor 520 to execute any function or process of controller 518. The computer memory may also be configured to hold additional data 526. In some examples, data 526 may include a register of classical control bits 528 that influence the operation of the quantum computer during run time—e.g., to provide classical control input to one or more quantum-gate operations. In examples in which qubit register 512 is a low-temperature or cryogenic device, controller 518 may include control componentry operable at low or cryogenic temperatures—e.g., a field-programmable gate array (FPGA) operated at 77K. In such examples, the low-temperature control componentry may be coupled operatively to interface componentry operable at normal temperatures.

Controller 518 of quantum computer 500 is configured to receive a plurality of inputs 530 and to provide a plurality of outputs 532. The inputs and outputs may each comprise digital and/or analog lines. At least some of the inputs and outputs may be data lines through which data is provided to and/or extracted from the quantum computer. Other inputs may comprise control lines via which the operation of the quantum computer may be adjusted or otherwise controlled.

Controller 518 is operatively coupled to qubit registers 512 via quantum interface 534. The quantum interface is configured to exchange data (solid lines) bidirectionally with the controller. The quantum interface is further configured to exchange signal associated with the data (dashed lines) bidirectionally with the qubit registers. Depending on the physical implementation of qubits 514, such signal may include electrical, magnetic, and/or optical signal. Via signal conveyed through the quantum interface, the controller may interrogate and otherwise influence the quantum state held in any, some, or all of the qubit registers, as defined by the collective quantum state of the qubits therein. To that end, the quantum interface includes qubit writer 536 and qubit reader 538. The qubit writer is configured to output a signal to one or more qubits of a qubit register based on write-data received from the controller. The qubit reader is configured to sense a signal from one or more qubits of a qubit register and to output read-data to the controller based on the signal. The read-data received from the qubit reader may, in some examples, be an estimate of an observable to the measurement of the quantum state held in a qubit register. Taken together, controller 518 and interface 534 may be referred to as a ‘control system’.

In some examples, suitably configured signal from qubit writer 536 may interact physically with one or more qubits 514 of a qubit register 512, to trigger measurement of the quantum state held in the one or more qubits. Qubit reader 538 may then sense a resulting signal released by the one or more qubits pursuant to the measurement, and may furnish read-data corresponding to the resulting signal to controller 518. Stated another way, the qubit reader may be configured to output, based on the signal received, an estimate of one or more observables reflecting the quantum state of one or more qubits of a qubit register, and to furnish the estimate to controller 518. In one non-limiting example, the qubit writer may provide, based on data from the controller, an appropriate voltage pulse or pulse train to an electrode of one or more qubits, to initiate a measurement. In short order, the qubit reader may sense photon emission from the one or more qubits and may assert a corresponding digital voltage level on a quantum-interface line into the controller. Generally speaking, any measurement of a quantum-mechanical state is defined by the operator O corresponding to the observable to be measured; the result R of the measurement is guaranteed to be one of the allowed eigenvalues of O. In quantum computer 500, R is statistically related to the qubit-register state prior to the measurement, but is not uniquely determined by the qubit-register state.

Pursuant to appropriate input from controller 518, quantum interface 534 may be configured to implement one or more quantum-logic gates to operate on the quantum state held in a qubit register 512. The term ‘state vector’ refers herein to the quantum state held in the series of qubits 514S of state register 512S of quantum computer 500. Whereas the function of each type of logic gate of a classical computer system is described according to a corresponding truth table, the function of each type of quantum gate is described by a corresponding operator matrix. The operator matrix operates on (i.e., multiplies) the complex vector representing a qubit register state and effects a specified rotation of that vector in Hilbert space.

For example, the Hadamard gate H is defined by

$$H = \frac{1}{\sqrt{2}} [ \begin{matrix}1 & 1 \\ 1 & - 1\end{matrix} ] . \qquad ( 1 )$$

The H gate acts on a single qubit; it maps the basis state |0 [symbol] to (|0 [symbol] +|1 [symbol] )/\sqrt{2}, and maps |1 [symbol] to (|0 [symbol] -|1 [symbol] )/\sqrt{2}. Accordingly, the H gate creates a superposition of states that, when measured, have equal probability of revealing |0 [symbol] or |1 [symbol] .

The phase gate S is defined by

$$S = [ \begin{matrix}1 & 0 \\ 0 & {e}^{i π / 2}\end{matrix} ] . \qquad ( 2 )$$

The S gate leaves the basis state |0 [symbol] unchanged but maps |1 [symbol] to e^{iπ/2}|1 [symbol] . Accordingly, the probability of measuring either |0 [symbol] or |1 [symbol] is unchanged by this gate, but the phase of the quantum state of the qubit is shifted. This is equivalent to rotating |ψ [symbol] by 90 degrees along a circle of latitude on the Bloch sphere of FIG. 6A.

Some quantum gates operate on two or more qubits. The SWAP gate, for example, acts on two distinct qubits and swaps their values. This gate is defined by

$$SWAP = [ \begin{matrix}1 & 0 & 0 & 0 \\ 0 & 0 & 1 & 0 \\ 0 & 1 & 0 & 0 \\ 0 & 0 & 0 & 1\end{matrix} ] . \qquad ( 3 )$$

A ‘Clifford gate’ is a quantum gate that belongs to the Clifford group—viz., a set of quantum gates that effect permutations of the Pauli operators. For the n-qubit case the Pauli operators form a group

$${P}_{n} = \{ {e}^{\frac{i θ π}{2}} {σ}_{{j}_{1}} ⊗ … ⊗ {σ}_{{j}_{n}} \vert θ = 0 , 1 , 2 , 3 , {j}_{k} = 0 , 1 , 2 , 3 \} , \qquad ( 4 )$$

where σ₀, . . . σ₃ are the single-qubit Pauli matrices. The Clifford group is then defined as the group of unitaries that normalize the Pauli group,

$${C}_{n} = \{ V ∈ {U}_{{2}^{n}} \vert V {P}_{n} {V}^{†} = {P}_{n} \} . \qquad ( 5 )$$

The foregoing list of quantum gates and associated operator matrices is non-exhaustive, but is provided for ease of illustration. Other quantum gates include Pauli −X, −Y, and −Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

Continuing in FIG. 5, suitably configured signal from qubit writer 536 of quantum interface 534 may interact physically with one or more qubits 514 of a qubit register 512 so as to assert any desired quantum-gate operation. As noted above, the desired quantum-gate operations include specifically defined rotations of a complex vector representing a qubit register state. In some examples, in order to effect a desired rotation O, the qubit writer may apply a predetermined signal level Sᵢ for a predetermined duration Tᵢ. In some examples, plural signal levels may be applied for plural sequenced or otherwise associated durations, as shown in FIG. 6B, to assert a quantum-gate operation on one or more qubits of a qubit register. In general, each signal level Sᵢ and each duration Tᵢ is a control parameter adjustable by appropriate programming of controller 518.

The terms ‘quantum circuit’ and ‘quantum algorithm’ are used herein to describe a predetermined sequence of elementary quantum-gate and/or measurement operations executable by quantum computer 500. A quantum circuit may be used to transform the quantum state of a qubit register 512 to effect a classical or non-elementary quantum-gate operation or to apply a density operator, for example. In some examples, a quantum circuit may be used to enact a predefined operation f(x), which may be incorporated into a complex sequence of operations. To ensure adjoint operation, a quantum circuit mapping n input qubits |x [symbol] to m output or auxiliary qubits |y=f(x) [symbol] may be defined as a quantum gate O(|x [symbol] ⊗|y [symbol] ) operating on the (n+m) qubits. In this case, O may be configured to pass the n input qubits unchanged but combine the result of the operation f(x) with the auxiliary qubits via an XOR operation, such that O(|x [symbol] ⊗|y [symbol] )=|x [symbol] ⊗|y⊕f(x) [symbol] .

Implicit in the description herein is that each qubit 514 of any qubit register 512 may be interrogated via quantum interface 534 so as to reveal with confidence the standard basis vector |0 [symbol] or |1 [symbol] that characterizes the quantum state of that qubit. In some implementations, however, measurement of the quantum state of a physical qubit may be subject to error. Accordingly, any qubit 514 may be implemented as a logical qubit, which includes a grouping of physical qubits measured according to an error-correcting quantum algorithm or circuit that reveals the quantum state of the logical qubit with above-threshold confidence.

Due to the difficulty of isolating qubits from their noisy environment, reliable execution of large-scale quantum algorithms will almost certainly require some form of quantum error correction. A ‘stabilizer code’ is a quantum error-correction circuit that includes sets of measurements for which the parity of outcomes is predetermined in the absence of errors. The measurements function as checks of the code, which can be used to identify errors and to correct errors via classical post processing.

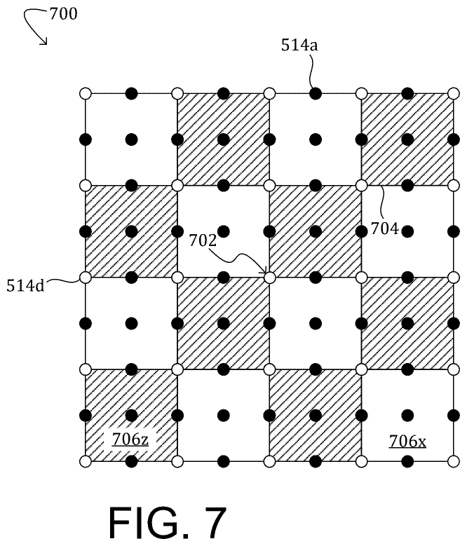

Some stabilizer codes leverage certain topological features of the qubit architecture of a quantum computer. To illustrate, FIG. 7 shows aspects of a regular lattice 700 of physical qubits 514. In the illustrated example, lattice 700 is a square lattice; that feature is not strictly necessary, however, as lattices of non-square and non-rectangular geometries are also envisaged. A qubit may be classified as a data qubit or as an ancillary qubit depending on how it is used. Data qubits 514D are shown as open circles in the drawings and are used to hold the evolving quantum state in a quantum computation. Ancillary qubits 514A are shown as filled circles in the drawings and are used internally by the quantum code executing on a quantum computer. In order to support quantum error correction, at least some of the information encoded in the data qubits may be stored redundantly, making use of the additional storage capacity of the ancillary qubits. In examples consonant with this disclosure, a topological stabilizer code (e.g., surface code) executes on the qubits of lattice 700. The topological stabilizer code enacts measurements on the qubits and, in some examples, may also enact one or more quantum-gate operations.

Lattice 700 comprises a matrix of vertices 702, which define a set of edges 704 and a set of plaqueless (or faces) 706. In the topological stabilizer code, a stabilizer operator Aᵢ operates on the qubits that surround each vertex i. In addition, a stabilizer operator Bᵢ operates on the physical qubits that define each plaquette j. The ‘stabilizer space’ of the topological stabilizer code is the vector space for which each of the operators A and B reduces to the identity operator. For a surface code (as one non-limiting example), the stabilizer space is four-dimensional and capable, therefore, of representing two logical qubits of quantum information. Generally speaking, each circuit fault will move the quantum state of lattice 700 out of the stabilizer space, resulting in vertices and faces for which operators A and or B differ from the identity operator. The positions of such anomalous operators on lattice 700 defines the ‘syndrome’ of the topological error-correcting quantum code, which can be used for error correction. In this process, a decoder program executing on a classical computer maps the syndrome to a series of bit flips, which may be applied to the measured output of a quantum algorithm, to yield an error-free result. Because the stabilizer code controls how the syndrome maps to the required bit flips, it also controls the build of the classical decoder. Currently, decoders based on topological stabilizer codes are the most efficient. For additional information, the interested reader is referred to the extensive literature on topological stabilizer codes.

With continued reference to FIG. 7, the measurement circuits of a topological stabilizer code are applied in sequence to one or more plaqueless of a qubit lattice as the code executes. Because neighboring plaqueless share qubits, and because any measurement on a given qubit can be made only once, there are a limited number of ways to extend the qubit measurements over the entire lattice, plaquette by plaquette. The available alternatives may be further constrained in scenarios where it is important to interrogate the entire lattice as rapidly as possible, in order to limit the decoherence that may occur between measurements.

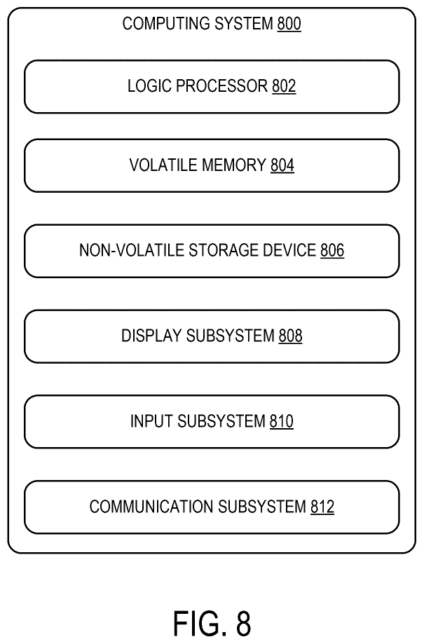

FIG. 8 schematically shows a non-limiting embodiment of a computing system 800 that can enact one or more of the methods and processes described above. Computing system 800 is shown in simplified form. Computing system 800 may embody classical computing device 20 described above and illustrated in FIG. 1. Components of computing system 800 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 800 includes a logic processor 802 volatile memory 804, and a non-volatile storage device 806. Computing system 800 may optionally include a display subsystem 808, input subsystem 810, communication subsystem 812, and/or other components not shown in FIG. 8.

Logic processor 802 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built in. Non-volatile storage device 806 may include optical memory, semiconductor memory, and/or magnetic memory, or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via logic processor 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, camera, or microphone.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 800 to send and/or receive messages to and/or from other devices via a network such as the Internet.

The following paragraphs describe additional examples of the present disclosure. According to one example, a computer-implemented method for solving a many-body quantum system problem is provided. The computer-implemented method comprises, at a classical computing device, receiving the many-body quantum system problem; receiving a portfolio of approximate candidate methods for solving the many-body quantum system problem; generating approximate solutions to the many-body quantum system problem using the portfolio of approximate candidate methods; providing a quantum computing device with the many-body quantum system problem and the approximate solutions; receiving from the quantum computing device a quantum energy for each of the approximate solutions; selecting one or more approximate candidate methods based on their respective quantum energy; and for each of the selected approximate candidate methods, solving the many-body quantum system problem using the one or more selected approximate candidate methods; and outputting properties of a quantum state for the many-body quantum system. In such an example, or any other example, the computer-implemented method additionally or alternatively comprises providing at least one selected approximate candidate method to the quantum computing device; and receiving a set of revised properties of the quantum state for the many-body quantum system from the quantum computing device. In any of the preceding examples, or any other example, one or more approximate candidate methods are additionally or alternatively selected for each of two or more phases for the many-body quantum system problem. In any of the preceding examples, or any other example, the computer-implemented method additionally or alternatively comprises outputting a phase diagram indicating properties of the quantum state for two or more phases of the many-body quantum system. In any of the preceding examples, or any other example, the many-body quantum system problem is additionally or alternatively one or more of a materials science problem, a chemistry problem, a biochemistry problem, a drug design problem, a nuclear matter problem, and a plasma problem. In any of the preceding examples, or any other example, an accuracy of the quantum energy is additionally or alternatively based on differences of quantum energies for the approximate candidate methods. In any of the preceding examples, or any other example, the approximate solutions additionally or alternatively comprise approximate ground states. In any of the preceding examples, or any other example, the approximate solutions additionally or alternatively comprise approximate wave functions. In any of the preceding examples, or any other example, the portfolio of approximate classical methods additionally or alternatively comprises one or more of variational Monte Carlo, density matrix renormalization group, matrix product states, fixed node Monte Carlo, released node Monte Carlo, machine learning wave functions, and dynamical mean field theory.

According to another example, a quantum computer-implemented method for solving a many-body quantum system problem is provided. The quantum computer-implemented method comprises receiving from a classical computing device: the many-body quantum system problem, and approximate solutions to the many-body quantum system generated using a portfolio of approximate candidate methods; determining a quantum energy for each of the approximate solutions using a quantum algorithm; and providing the classical computing device with the quantum energy for each of the approximate solutions. In such an example, or any other example, the quantum computer-implemented method additionally or alternatively comprises receiving at least one selected approximate candidate method from the classical computing device; generating a set of revised properties of a quantum state for the many-body quantum system based on the at least one selected approximate candidate method; and providing the set of revised properties of the quantum state to the classical computing device. In any of the preceding examples, or any other example, the quantum algorithm additionally or alternatively comprises quantum phase estimation. In any of the preceding examples, or any other example, the quantum phase estimation additionally or alternatively comprises one or more of Trotterization, qubitization, and quantum signal processing as an underlying decomposition.

According to yet another example, a computing system is provided. The computing system comprises a classical computing device comprising one or more processing devices; a quantum computing device communicatively coupled to the classical computing device; and instructions stored in memory to, at the classical computing device, receive a many-body quantum system problem; receive a portfolio of approximate candidate methods for solving the many-body quantum system problem; generate approximate solutions to the many-body quantum system problem using the portfolio of approximate candidate methods; and provide the quantum computing device with the many-body quantum system problem and the approximate solutions; at the quantum computing device, determine a quantum energy for each of the approximate solutions using a quantum algorithm; at the classical computing device, receive from the quantum computing device the quantum energy for each of the portfolio of approximate candidate methods; select one or more approximate candidate methods based on their respective quantum energy; and for each of the selected approximate candidate methods, solve the many-body quantum system problem using the one or more selected approximate candidate methods; and output properties of a quantum state for the many-body quantum system. In such an example, or any other example, the computing system additionally or alternatively comprises instructions stored in memory to, at the classical computing device, provide at least one selected approximate candidate method to the quantum computing device; at the quantum computing device, receive at least one selected approximate candidate method from the classical computing device; generate a set of revised properties of the quantum state for the many-body quantum system based on the at least one selected approximate candidate method; and provide the set of revised properties of the quantum state to the classical computing device; and at the classical computing device, receive a set of revised properties of the quantum state for the many-body quantum system from the quantum computing device. In any of the preceding examples, or any other example, one or more approximate candidate methods are additionally or alternatively selected for each of two or more phases for the many-body quantum system problem. In any of the preceding examples, or any other example, the computing system additionally or alternatively comprises instructions stored in memory to, at the classical computing device, output a phase diagram indicating properties of the quantum state for two or more phases of the many-body quantum system. In any of the preceding examples, or any other example, the portfolio of approximate classical methods additionally or alternatively comprises one or more of variational Monte Carlo, density matrix renormalization group, matrix product states, fixed node Monte Carlo, released node Monte Carlo, machine learning wave functions, and dynamical mean field theory. In any of the preceding examples, or any other example, the quantum algorithm additionally or alternatively comprises quantum phase estimation. In any of the preceding examples, or any other example, the quantum phase estimation additionally or alternatively comprises one or more of Trotterization, qubitization, and quantum signal processing as an underlying decomposition.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer-implemented method for solving a many-body quantum system problem, comprising:
at a classical computing device,
receiving the many-body quantum system problem;
receiving a portfolio of approximate candidate methods for solving the many-body quantum system problem;
generating approximate solutions to the many-body quantum system problem using the portfolio of approximate candidate methods;
providing a quantum computing device with the many-body quantum system problem and the approximate solutions;
receiving from the quantum computing device a quantum energy for each of the approximate solutions;
selecting one or more approximate candidate methods based on their respective quantum energy; and
for each of the selected approximate candidate methods,
solving the many-body quantum system problem using the one or more selected approximate candidate methods; and
outputting properties of a quantum state for the many-body quantum system.

2. The computer-implemented method of claim 1, further comprising:
providing at least one selected approximate candidate method to the quantum computing device; and
receiving a set of revised properties of the quantum state for the many-body quantum system from the quantum computing device.

3. The computer-implemented method of claim 1, wherein one or more approximate candidate methods are selected for each of two or more phases for the many-body quantum system problem.

4. The computer-implemented method of claim 3, further comprising:
outputting a phase diagram indicating properties of the quantum state for two or more phases of the many-body quantum system.

5. The computer-implemented method of claim 1, wherein the many-body quantum system problem is one or more of a materials science problem, a chemistry problem, a biochemistry problem, a drug design problem, a nuclear matter problem, and a plasma problem.

6. The computer-implemented method of claim 1, wherein an accuracy of the quantum energy is based on differences of quantum energies for the approximate candidate methods.

7. The computer-implemented method of claim 1, wherein the approximate solutions comprise approximate ground states.

8. The computer-implemented method of claim 1, wherein the approximate solutions comprise approximate wave functions.

9. The computer-implemented method of claim 1, wherein the portfolio of approximate classical methods comprises one or more of variational Monte Carlo, density matrix renormalization group, matrix product states, fixed node Monte Carlo, released node Monte Carlo, machine learning wave functions, and dynamical mean field theory.

10. A quantum computer-implemented method for solving a many-body quantum system problem, comprising:
receiving from a classical computing device:
the many-body quantum system problem, and
approximate solutions to the many-body quantum system generated using a portfolio of approximate candidate methods;
determining a quantum energy for each of the approximate solutions using a quantum algorithm; and
providing the classical computing device with the quantum energy for each of the approximate solutions.

11. The quantum computer-implemented method of claim 10, further comprising:
receiving at least one selected approximate candidate method from the classical computing device;
generating a set of revised properties of a quantum state for the many-body quantum system based on the at least one selected approximate candidate method; and
providing the set of revised properties of the quantum state to the classical computing device.

12. The quantum computer-implemented method of claim 10, wherein the quantum algorithm comprises quantum phase estimation.

13. The quantum computer-implemented method of claim 12, wherein the quantum phase estimation comprises one or more of Trotterization, qubitization, and quantum signal processing as an underlying decomposition.

14. A computing system, comprising:
a classical computing device comprising one or more processing devices;
a quantum computing device communicatively coupled to the classical computing device; and
instructions stored in memory to:
at the classical computing device:
receive a many-body quantum system problem;
receive a portfolio of approximate candidate methods for solving the many-body quantum system problem;
generate approximate solutions to the many-body quantum system problem using the portfolio of approximate candidate methods; and
provide the quantum computing device with the many-body quantum system problem and the approximate solutions;
at the quantum computing device:
determine a quantum energy for each of the approximate solutions using a quantum algorithm;
at the classical computing device:
receive from the quantum computing device the quantum energy for each of the portfolio of approximate candidate methods;
select one or more approximate candidate methods based on their respective quantum energy; and
for each of the selected approximate candidate methods,
solve the many-body quantum system problem using the one or more selected approximate candidate methods; and
output properties of a quantum state for the many-body quantum system.

15. The computing system of claim 14, further comprising instructions stored in memory to:
at the classical computing device:
provide at least one selected approximate candidate method to the quantum computing device;
at the quantum computing device:
receive at least one selected approximate candidate method from the classical computing device;
generate a set of revised properties of the quantum state for the many-body quantum system based on the at least one selected approximate candidate method; and
provide the set of revised properties of the quantum state to the classical computing device; and
at the classical computing device:
receive a set of revised properties of the quantum state for the many-body quantum system from the quantum computing device.

16. The computing system of claim 14, wherein one or more approximate candidate methods are selected for each of two or more phases for the many-body quantum system problem.

17. The computing system of claim 16, further comprising instructions stored in memory to:
at the classical computing device:
output a phase diagram indicating properties of the quantum state for two or more phases of the many-body quantum system.

18. The computing system of claim 14, wherein the portfolio of approximate classical methods comprises one or more of variational Monte Carlo, density matrix renormalization group, matrix product states, fixed node Monte Carlo, released node Monte Carlo, machine learning wave functions, and dynamical mean field theory.

19. The computing system of claim 14, wherein the quantum algorithm comprises quantum phase estimation.

20. The computing system of claim 19, wherein the quantum phase estimation comprises one or more of Trotterization, qubitization, and quantum signal processing as an underlying decomposition.
